(19) United States
(12) Patent Application Publication
(10) Pub. No.: US 2013/0070790 A1
(43) Pub. Date: Mar. 21, 2013

(54) SUPERFRAME FORMAT FOR MV-LV COMMUNICATION IN MULTI TONE-MASK PLC NETWORKS

(71) Applicants: Ramanuja VEDANTHAM, Allen, TX (US); Kumaran VIJAYASANKAR, Dallas, TX (US); Anand DABAK, Plano, TX (US)

(72) Inventors: Ramanuja VEDANTHAM, Allen, TX (US); Kumaran VIJAYASANKAR, Dallas, TX (US); Anand DABAK, Plano, TX (US)

(73) Assignee: TEXAS INSTRUMENTS INCORPORATED, Dallas, TX (US)

(21) Appl. No.: 13/621,581

(22) Filed: Sep. 17, 2012

Related U.S. Application Data
(60) Provisional application No. 61/535,561, filed on Sep. 16, 2011.

(51) Int. Cl. H04L 29/00

(52) U.S. Cl. 370/474

(57) ABSTRACT

A method for multi-tone mask communication including generating, by a power line communication router, a superframe to include a plurality of beacons corresponding to a plurality of tone masks. Each beacon also defining a plurality of tone masks, a contention access region, a contention free period, an inter router communication slot. The superframe also includes at least one of the beacons also defining an idle time during which nodes receiving the superframe are to transition to a low power mode. Transmitting the superframe to a power line communication node.

### CROSS-REFERENCE TO RELATED APPLICATION

The present application claims priority to U.S. Provisional Patent Application No. 61/535,561 filed on Sep. 16, 2011 (Attorney Docket No. TI-71469PS); which is hereby incorporated herein by reference.

### BACKGROUND

This disclosure is directed, in general, to Power Line Communications and, more specifically, to a superframe format and method for using same in Power Line Communication PLC networks.

Power Line communications (PLC) include systems for communicating data over the same medium that is also used to transmit electric power to residences, buildings, and other premises. Once deployed, PLC systems may enable a wide array of applications such as automatic meter reading and load control (i.e., utility-type applications), automotive uses (e.g., charging electric cars), home automation (e.g., controlling appliances, lights, etc.), and/or computer networking (e.g., Internet access), to name only a few.

Current and next generation narrow-band PLC are multi-carrier based and may use orthogonal frequency division multiplexing (as opposed to frequency shift keying) in order to achieve higher network throughput. OFDM uses multiple orthogonal subcarriers to transmit data over frequency selective channels. These PLC networks, however, require a media access code (MAC) protocol to govern communication between nodes of the system. The MAC protocol structures the transmissions that occur and the frequencies that are used for those transmissions. PLC networks typically use multiple sub-bands to communicate due to the characteristics of the power grid and the number of nodes communicating.

Multi-Tone Mask (MTM) mode (or “tone masking”) refers to the use of multiple tone masks/sub-bands to enable nodes in the network to use individual tone masks within the band optimized for the local conditions on the network. PLC networks may typically use network communication protocols based on the IEEE P1901.2. MTM mode for tones allows avoidance of parts of the network spectrum occupied by high levels of external noise and allows for each router-node pair to select the optimal tone mask for communication. MTM mode also allows co-existence with incumbent communication technologies (such IEEE P1901.2 with IEC 61334, IEEE P1901 and ITU G.hn) that might be sharing the PLC channel.

### SUMMARY

The problems noted above are solved in large part by embodiments directed to a method for multi-tone mask communication including generating, by a power line communication router, a superframe to include a plurality of beacons corresponding to a plurality of tone masks. Each beacon also defining a plurality of tone masks, a contention access region, a contention free period, an inter router communication slot. The superframe also includes at least one of the beacons also defining an idle time during which nodes receiving the superframe are to transition to a low power mode. Transmitting the superframe to a power line communication node.

Other embodiments are directed toward a system for power line communications using a multi-tone mask including a processor configured to generate a superframe to include a plurality of beacons corresponding to a plurality of tone masks. Each beacon then defines the plurality of tone masks, a contention access region, a contention free period, and an inter router communication slot, and at least one beacon also defining an idle time during which nodes receiving the superframe are to transition to a low power mode. Also included is a modem coupled to the processor configured to transmit the superframe to a node.

Another embodiment is directed toward a method for multi-tone mask communication including generating, by a power line communication router, a superframe that includes a plurality of beacons corresponding to a plurality of tone masks. Each beacon defining the plurality of tone masks, a plurality of contention access periods each having a different length, a contention free period, and an inter router communication region and transmitting the superframe to a power line communication node.

Other embodiments are directed toward a system for power line communications using a multi-tone mask mode including a processor configured to generate a superframe that includes a plurality of beacons defining a plurality of tone masks, a plurality of contention access periods each having a different length, a contention free period, and an inter router communication region. The system also includes a modem coupled to the processor configured to transmit the superframe to a node.

Yet another embodiment is directed toward a system for multi-tone mask mode communication through transformers between routers on medium voltage power lines and nodes on low voltage power lines including a processor configured to generate a superframe. The superframe includes a beacon region comprising a plurality beacon frames corresponding to a plurality of tone masks. Each beacon frame at least defines: the plurality of tone masks; a contention access period region comprising a plurality of contention access periods wherein each contention access period corresponds to one of the plurality of tone masks and there is one beacon frame and one contention access period for each tone mask; a contention free period poll access region wherein the routers contend for access; a contention free period used only by the router than won contention during the contention free period poll access region; a guard region after the contention free period but before an inter router communication region wherein the router finalizes all communications with the nodes so that the modems can synchronize; the inter router communication region wherein the routers communicate with one another using all tone masks; a guard region before end of frame to finalize all inter router communications; and an idle time. The system further includes a modem coupled to the processor configured to transmit the superframe to the nodes.

### BRIEF DESCRIPTION OF THE DRAWINGS

Having thus described the invention in general terms, reference will now be made to the accompanying drawings, which are not necessarily drawn to scale, and wherein:

FIG. 1 shows a representation of a PLC network in accordance with various embodiments;

FIG. 2 shows superframe structure format when used for a PLC network with N tone masks in accordance with various embodiments;

FIG. 3 shows a block diagram of a system for generating and transmitting a superframe in accordance with various embodiments; and

FIG. 4 shows a method for generating and transmitting a superframe in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections.

As used herein, the term “full band” or “full mask” refers to the total frequency range available to the PLC networks and may range from 150 to 500 KHz.

As used herein, the term “multi-tone mask,” “tone mask” or “tone masking” refers to the process of using sub-bands of the available frequency range to communicate with the various routers and nodes on the network.

As used herein, the term “sub-network” or “neighborhood” refers to one router of a PLC network paired with a number of nodes, up to N, on the PLC network.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

The preferred embodiments now will be described more fully hereinafter with reference to the accompanying drawings. The embodiment, however, may be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

In accordance with various embodiments, a PLC network includes modems/routers on medium voltage (MV) power lines (typical voltages range from 10 to 35 kV), which communicate through transformers with nodes/devices on the low voltage (LV) distribution network (typical voltages range from 220 to 240 V). Modems or routers on the MV lines may also communicate with one another and one of the routers may be designated as a master router. The master router will be the gateway to the backbone for delivering data to a command center and will also transmit commands and data from the command center to the rest of the network.

Nodes in these networks may refer to houses and buildings connected to the power grid, but may be any type of structure using power from the LV lines. The nodes may use the power meter as the communication gateway to the PLC, but may also use an appliance or any other device configured to transmit and receive the requisite communication format as the gateway. As mentioned above, power transmission systems were designed for very low frequencies and may have an upper limit to the frequencies that the lines can transmit. A typical frequency range available to a PLC network is 150-500 KHz. Additionally, the routers and nodes communicate with each other through transformers, which also affects the frequencies each node may be able to receive. Transformers affect the frequency range due to the impedance characteristics of each individual transformer and due to the transformers being low-pass filters.

Thus, the full spectrum, or full band, available to the network may be broken into sub-bands, or tone masks, so that each node may use a tone mask optimized for the impedance of the line between the node and the router. Thus, the sub-bands that one node receives may be different than the sub-bands that the next node receives, Moreover, the sub-bands each node can use for transmitting to the router may also be different from the sub-band that node uses for receiving messages from the router. Hence, for each router-node pair communicating through a different transformer, there will be a different sub-band used for downlink (DL) communications (router to node) and a different sub-band used for uplink (UL) communications (node to router). The DL and UL sub-bands chosen for each router-node pair may be selected from those sub-bands with optimal signal-to-noise ratios.

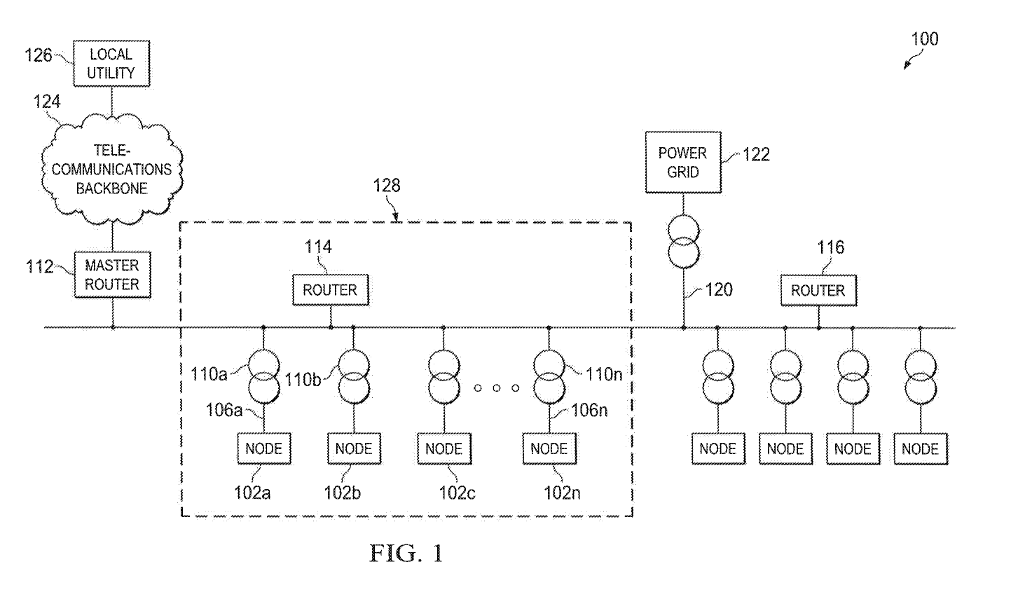

FIG. 1 illustrates one embodiment of a PLC network 100 for a local utility PLC communications system. Network 100 includes LV nodes 102a through 102n and each of the nodes 102a-n is connected to MV power line 120 through a corresponding transformer 110a through 110n and LV line 106a through 106n. Router, or modem, 114 is also connected to MV power line 120. A sub-network 128, or neighborhood 128, may be represented by the combination of nodes 102a-n and router 114. Master router 112 and router 116 are also connected to MV line 120, which is powered by power grid 122. Power grid 122 represents the high voltage power distribution system.

Master router 112 may be the gateway to telecommunications backbone 124 and local utility, or control center, 126. Master router 112 may transmit data collected by the routers to the local utility 126 and may also broadcast commands from local utility 126 to the rest of the network. The commands from local utility 126 may require data collection at prescribed times, changes to communication protocols, and other software or communication updates.

During UL communications, the nodes 102a-n in neighborhood 128 may transmit usage and load information (“data”) through their respective transformer 110a-n to the MV router 114. In turn, router 114 forwards this data to master router 112, which sends the data to the utility company 126 over the telecommunications backbone 124. During DL communications (router 114 to nodes 102a-n) requests for data uploading or commands to perform other tasks are transmitted.

In accordance with various embodiments, the superframe structure may be implemented to coordinate communication by PLC network 100, which would also be implemented by neighborhood 128. The superframe may include multiple regions with each region dedicated to a specific task by a router, as in router 114, a node, as in node 102a, or both. However, during some of the regions multiple routers and multiple nodes may be transmitting simultaneously. The various regions of the superframe must also be synchronized throughout network 100 because some regions of the superframe may allow access to network 100 by only one router. Thus, the superframe format may allow the local utility 126 to uniformly control communication within the network 100.

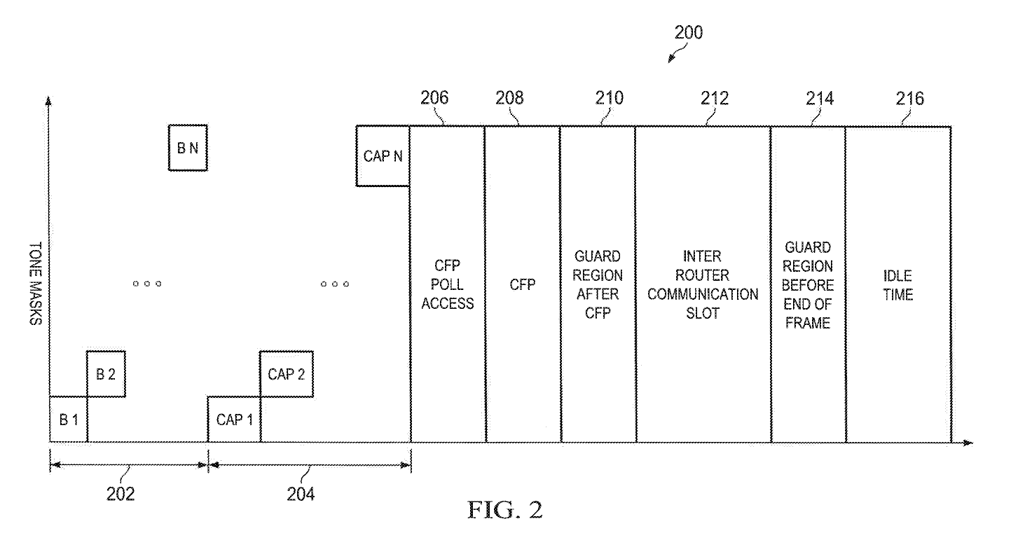

In accordance with various embodiments, as shown in FIG. 2, the superframe may include the following regions: a beacon region; a contention access region; a contention free period (CFP) poll access region; a CFP; a guard region after CFP; an inter router communication slot region; a guard region before end of frame; and an idle time region. The regions may be used in the sequence just listed but may also be used in other sequences. Additionally, not all regions may always be utilized. The superframe structure may be dictated to the network by local utility 126 via master router 112. However, each router, as in router 114, may have some autonomy within each of the regions so long as the beginning and ending of each region is synchronized across network 100.

The illustrating superframe 200 of FIG. 2 provides tone mask assignments and timing assignments for the various regions which enables MTM mode operation in a PLC network, such as the PLC network 100 depicted in FIG. 1. The superframe 200 is useful for cases where the MTM mode is applied to a MV-LV application where a MV node operates as a router 114, and nodes 102a-n try to associate with router 114, and the routers 114 and nodes 102a-n communicate with one another through their respective transformers 110a-n.

Superframe 200 includes a plurality of beacon frames (B1, B2, . . . BN) within a beacon period 202 of the super-frame 200, with a beacon frame for each of the available N tone masks, if network 100's available full mask is divided into N tone masks. There are thus N beacon frames in N beacon slots with one beacon frame for each tone mask available or allotted. The beacons (B1, B2, . . . BN) include time and sequencing assignments within the superframe including time assignments for the CAP slots and for the CFP period, and tone mask assignments for the N tone masks in the CAP slots, the CFP poll access region, the CFP region, the two guard regions, the IRCS, the idle time region, as well as a conventional timestamp for local clock synchronization, beacon interval information, device/network capability information, whether polling is supported, and encryption details.

Superframe 200 includes CAP region 204 including multiple CAP slots, with one CAP slot allocated for each of the N tone masks and corresponding to one of the N beacons. Each CAP slot is also characterized by its own minimum length of symbols, aMinCAPLength symbols, which is a function of the associated tone mask. A minimum length is required because the number of symbols needed to carry a joining request frame depends on the frequency of the tone mask. Tone masks that have a smaller number of tones, shorter frequencies, take longer to transmit and require more symbols whereas tone masks with a larger number of tones, higher frequencies, require fewer symbols to communicate the same information. Thus, the length of the CAP slot is inversely related to the tone mask. The aMinCAPLength is calculated by the node, not transmitted by the beacons.

A CFP poll access period 206 is also included in superframe 200, during which routers, such as routers 114 and 116, contend for access to use the CFP 208. CFP 208 refers to contention-free access where the router that won contention during CFP poll access period 206 transmits requests for data to the nodes and the nodes respond with any available data. For example, if router 114 won contention, then it would poll nodes during CFP requesting data. Superframe 200 may also include guard region after CFP 210, which is used to conclude any communications lagging from CFP 208. Guard region 210 is also used to ensure that routers are synchronized at the start of IRCS 212. IRCS 212 is used for routers to communicate with each other, which may include the master router 112 requesting data from routers 114 and 116 to forward on to local utility 126 via backbone 124. IRCS 212 may also be used for master router 112 to transmit a new format to superframe 200 to the routers and nodes of the network, such as router 114 and nodes 102a-n. Communication that occurs during IRCS 212 may use the full band, the full tone mask, for transmissions, not just a single sub-band or tone mask.

Superframe 200 also includes another guard region after IRCS 212. Guard region before end of frame 214 may be used to conclude transmissions between the routers. Superframe 200 then concludes with idle time 216. Idle time 216 is used by the devices of network 100, such as router 116 and nodes 102a-n, to complete tasks not requiring any transmissions on network 100. Idle time 216 may also be used to transition to a lower power mode or to perform local updates. Nodes 102a-n may use idle time 216 to gather data from energy thirsty components at the node level, such as car charging stations, appliances, etc. The idle time 216's length and sequence within superframe 200 is fully described in at least one beacon or may be described in each beacon. In various other embodiments, ide time 216 start time and end time will be described in at least one of the N beacons of beacon frame 202.

As discussed previously, superframe 200's structure, i.e., the length of each region and the sequence of the regions, can be altered by local utility 126 at any time. Changes to superframe 200 will be communicated to the other routers and the nodes of the network by master router 112. Additionally, each region of superframe 200 may not always be required and additional regions may be inserted that allows for other types of communication. Moreover, although master router 112 dictates the overall structure of superframe 200, each router may alter the number and timing of the N beacons and N CAP slots used in its neighborhood 128 so long as CFP poll access region 206 is synchronized for the entire network 100.

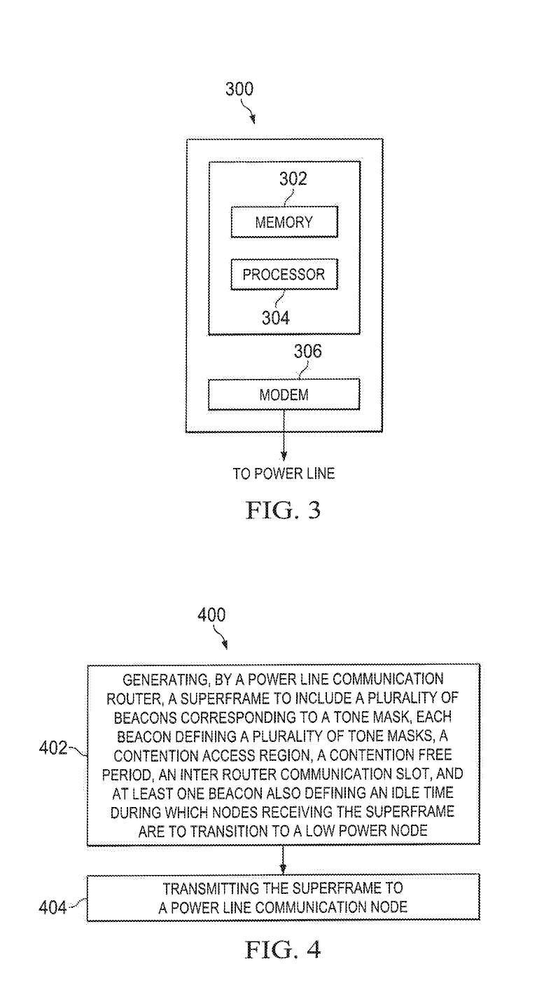

FIG. 3 is a block diagram schematic of a communications system 300 that may include memory 302, processor 304 and modem 306. Memory 302 holds the timing, length, and sequence information for various superframe formats including superframe 200 along with the N tone masks available to the network 100. Processor 304 uses the superframe information stored in memory 302 to generate the superframe and beacons that will be transmitted by modem 306. System 300 may represent a router, such as router 114, or a node, such as node 102a, and is configured to transmit and receive signals sent on the N tone masks and may use the full band as well. If system 300 is configured as a router, then it is connected to MV power line 120. If system 300 is configured as a node, then it will be connected to a LV power line, such as LV power line 106a.

In various embodiments, modem 306 of system 300 may be used in a PLC network to provide a networked device that in service is connected to a power line via a power cord. In general, the “networked device” can be any equipment that is capable of transmitting and/or receiving information over a power line. Examples of different types of networked devices include, but are not limited or restricted to a computer, a router, an access point (AP), a wireless meter, a networked appliance, an adapter, or any device supporting connectivity to a wired or wireless network.

In various embodiments, the nodes and routers initialize before data and commands can be transmitted across the PLC network 100. This initialization process establishes the UL and DL tone masks used between the router-node pairs, like router 114 paired with node 102b through transformer 110b. For example, node 102b would switch a receiver to tone mask 1 associated with beacon 1. If node 102b was using system 300, then modem 306 would be set to receive tone mask 1. Node 102b may then listen for beacon B1 on tone mask 1 for the full length of superframe superframe 200. If no signal is received, then node 102b would change the modem 306 to listen for beacon 2 on tone mask 2. If a signal is received, node 102b may produce a report regarding the signal quality received. This process is then completed for all N beacons.

After a superframe has been transmitted for each beacon by a router to its neighborhood, such as router 114 to nodes 102a-n in neighborhood 128, then each node will produce a DL report outlining what tone masks they received and their respective signal qualities. After all beacons have been transmitted, then the process is reversed in which the nodes will transmit their DL report during each CAP slot of a superframe to the neighborhood router, like router 114. All nodes will be transmitting over all N tone masks but the router may not receive a DL report on each tone mask from each node due to the characteristics of the local MV-LV line and transformer sub-network. The router will then create an UL report detailing which nodes' DL reports were received on which tone masks and the respective signal quality. The router will then use the two reports to determine what tone masks will be used for DL and UL communications with each node in its neighborhood—a tone mask allocation report. The router then transmits the tone mask allocation report to the neighborhood during each CAP slot and during CFP on a subsequent superframe.

In another embodiment, the nodes 102a-n will switch their modems 306 to the tone mask associated with each beacon frame to listen for each beacon in a single superframe, and then each node 102a-n will transmit their DL report during each CAP slot of a subsequent superframe. In another embodiment, a DL report associated with a single beacon could be sent to the router during the CAP slot corresponding to that beacon. Additionally, the initialization process may be used by each router individually to determine the optimal DL and UL tone masks to use with all nodes on the network, not just the nodes in that router's neighborhood. This will allow communication with each node during CAP slots and CFP.

Once the nodes and routers have been initialized and the respective DL and UL tone masks have been established, then the network may operate in a steady state mode until changes are made to the superframe or more tone masks are made available to the network. During steady state operation the routers and nodes may either transfer data between one another during CAP slots or during CFP. Communication taking place in a neighborhood during CAP slots, such as neighborhood 128, may occur simultaneously to other neighborhoods on the network communicating between their router and nodes. However, communication occurring during CFP will only take place between one router and one node at a time and the node may not transmit data to the router until polled by that router.

In one embodiment, to transfer data during a steady state operation mode, the router will poll a specific node during a CAP slot associated with the DL tone associated with that node and that CAP slot. The node will then transmit an acknowledgment (ACK) to the router using the UL tone mask the node was assigned for UL transmissions. For example, router 114 will transmit on tone mask 1 during CAP slot 1 intended for node 102b. After router 114 transmits the signal, router 114 will switch its modem to listen to tone mask 3 for certain amount of time. After nod 102b receives the signal from router 114, node 102b switches its modem to transmit on tone mask 3 and transmits an ACK to router 114. Conversely, node 102b could transmit data to router 114 during CAP slot 3 on tone mask 3 then switch its modem to receive on tone mask 1 to wait for an ACK signal. Router 114 would then send an ACK signal on tone mask 1 once the data was received.

The same process may also be used during the CFP region of superframe 200. During CFP, router 114 would poll node 102b for data on tone mask 1, to continue with the above example. Node 102b would then transmit any data it had acquired to router 114 on tone mask 3, which would be followed by router 114 transmitting an ACK on tone mask 1. In some embodiments, the communication taking place during the CFP region will occur one node at a time—poll node, receive data from node, and transmit ACK to node. However, in various other embodiments, the router may send out a poll on multiple tone masks simultaneously and wait to receive data from the nodes associated with those tone masks before polling another group of nodes. In such an embodiment, the router could send an ACK as data is received by the polled node or wait to receive all data before transmitting an ACK to that group of nodes simultaneously.

FIG. 4 shows a method 400 of generating and transmitting a superframe in accordance with various embodiments. The method 400 begins at block 402 with generating a superframe to at least contain a plurality of beacons corresponding to a tone mask, each beacon defining a plurality of tone masks, a contention access region, a contention free period, an inter router communication slot, and at least one beacon also defining an idle time during which nodes receiving the superframe are to transition to a low power mode. The method 400 continues at block 402 with transmitting the superframe to a node.

In one embodiment, the superframe will be generated by a master router, such as master router 112, and will be transmitted to all the nodes and other routers of the network. In another embodiment, the superframe will be generated by a non-master router, such as router 114, and will be transmitted to the nodes of its neighborhood, such as neighborhood 128. In yet another embodiment, the superframe may be generated by a node, such as node 102c, and by transmitted to the nodes in its neighborhood, such as neighborhood 128.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method for multi-tone mask communication, comprising:
generating, by a power line communication router, a superframe to include a plurality of beacons corresponding to a plurality of tone masks, each beacon defining the plurality of tone masks, a contention access region, a contention free period, an inter router communication slot, and at least one beacon also defining an idle time during which nodes receiving the superframe are to transition to a low power mode; and
transmitting the superframe to a power line communication node.

2. The method of claim 1 further comprising:
receiving, by the power line communication node, the superframe;
decoding a beacon to at least identify the idle time's length and the idle time's location within the superframe with respect to the contention access region, the contention free period, and the inter router communication slot; and
transitioning to a lower power mode during the idle time.

3. The method of claim 1 further comprising:
defining, by at least one of the beacons, a guard region occurring after the contention free period region where lagging communication between the router and the node is concluded before an end of the guard region and before the inter router communication slot begins.

4. A system for power line communications using a multi-tone mask, comprising:
a processor configured to generate a superframe to include a plurality of beacons corresponding to a plurality of tone masks, each beacon defining the plurality of tone masks, a contention access region, a contention free period, and an inter router communication slot, and at least one beacon also defining an idle time during which nodes receiving the superframe are to transition to a low power mode; and
a modem coupled to the processor configured to transmit the superframe to a node.

5. The system of claim 4 wherein at least one beacon defines a guard region occurring after the contention free period in which all communication between the modem and the node is concluded before the inter router communication slot begins.

6. The system of claim 4 wherein at least one beacon defines a length of the idle time as well as a timing relationship of the idle time to the contention access region, the contention free period and the inter router communication slot.

7. The system of claim 4 wherein the contention access region further comprises a plurality of contention access periods, each contention access period corresponding to one of the beacons.

8. The system of claim 7 wherein each of the plurality of tone masks is associated with one of the beacons and the corresponding contention access period.

9. The method of claim 8 wherein each contention access period has a length that is at least a predetermined number of symbols dictated by the corresponding tone mask.

10. The system of claim 4 wherein:
the node comprises a receiver configured to decode at least one beacon to identify the length of the idle time and a position of the idle time within the superframe with respect to the contention access region, the contention free period, and the inter router communication slot.

11. A method for multi-tone mask communication, comprising:
generating, by a power line communication router, a superframe that includes a plurality of beacons corresponding to a plurality of tone masks, and each beacon defining a plurality of tone masks, a plurality of contention access periods each having a different length, a contention free period, and an inter router communication region; and
transmitting the superframe to a power line communication node.

12. The method of claim 11 wherein each of the plurality of contention access periods corresponds to one of the plurality of beacons and each of the plurality of tone masks corresponds to a beacon and a contention access period.

13. The method of claim 11 further comprising:
receiving, by the power line communication node, the superframe; and
decoding at least one beacon to identify the length of each contention access period, wherein the length of each contention access period is at least a predetermined number of symbols dictated by the corresponding tone mask.

14. The method of claim 11 further comprising:
defining, by a beacon, a guard region occurring after the contention free period where lagging communication between the power line communication router and the power line communication node is concluded before the inter router communication region.

15. A system for power line communications using a multi-tone mask mode, comprising:
a processor configured to generate a superframe that includes a plurality of beacons corresponding to a plurality of tone masks and each beacon defining the plurality of tone masks, a plurality of contention access periods each having a different length, a contention free period, and an inter router communication region; and
a modern coupled to the processor configured to transmit the superframe to a node.

16. The system of claim 15 wherein a beacon defines a guard region after the contention free period, the guard region used to conclude lagging communication between the modem and the node before the inter router communication slot begins.

17. The system of claim 15 wherein at least one beacon defines a length of an idle time and a timing relationship of the idle time to the plurality of contention access periods, the contention free period and the inter router communication slot.

18. The system of claim 15 wherein each of the contention access periods has a different length and each contention access periods corresponds to one of the beacons.

19. The system of claim 18 wherein one of the plurality of tone masks is used by a corresponding beacon and contention access period pair such that each tone mask is used by only one beacon and that beacon's corresponding contention access period.

20. The method of claim 18 wherein the length of each contention access period is at least a predetermined number of symbols that is dictated by the corresponding tone mask.

21. The method of claim 18 wherein each tone mask has a frequency, the frequency varying between the tone masks, and wherein the length of each contention access period is inversely related to the frequency of the corresponding tome mask.

22. The system of claim 15 wherein the node comprises:
a receiver configured to decode a beacon to at least identify the length of each of the plurality of contention access regions.

23. A system for mufti-tone mask mode communication through transformers between routers on medium voltage power lines and nodes on low voltage power lines, comprising:
a processor configured to generate a superframe to include:
a beacon region comprising a plurality beacon frames corresponding to a plurality of tone masks where each beacon frame at least defines:
the plurality of tone masks;
a contention access period region comprising a plurality of contention access periods wherein each contention access period corresponds to one of the plurality of tone masks and there is one beacon frame and one contention access period for each tone mask;
a contention free period poll access region wherein the routers contend for access;
a contention free period used only by the router than won contention during the contention free period poll access region;
a guard region after the contention free period but before an inter router communication region wherein the router finalizes all communications with the nodes so that the modems can synchronize;
the inter router communication region wherein the routers communicate with one another using all tone masks;
a guard region before end of frame to finalize all inter router communications; and
an idle time; and
a modem coupled to the processor configured to transmit the superframe to the nodes.
